(19) United States
(12) Patent Application Publication
(10) Pub. No.: US 2008/0046730 A1
(43) Pub. Date: Feb. 21, 2008

(54) Method and apparatus for providing content encrypted using broadcast encryption scheme in local server

(75) Inventors: Sung-hyu Han, Seoul (KR); Myung-sun Kim, Uiwang-si (KR); Young-sun Yoon, Suwon-si (KR); Sun-nam Lee, Suwon-si (KR); Jae-heung Lee, Suwon-si (KR); Bong-seon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/368,710

(22) Filed: Mar. 7, 2006

Related U.S. Application Data
(60) Provisional application No. 60/658,591, filed on Mar. 7, 2005.

(30) Foreign Application Priority Data
Apr. 6, 2005 (KR) 10-2005-0028516

(51) Int. Cl. H04L 9/00

(52) U.S. Cl. 713/171

(57) ABSTRACT

A method and an apparatus for providing content encrypted in a broadcast encryption scheme to a plurality of devices in a local network are provided. The method includes: storing a minimal number of keys needed by the devices to decode the encrypted content among a plurality of keys that can be used in the predetermined encryption scheme; and transmitting the stored keys to the devices. Accordingly, it is possible for a local server having a small storage capacity to provide the encrypted content to the devices by storing only the minimal number of keys needed by the devices to decode the encrypted content.

### CROSS-REFERENCE TO RELATED PATENT APPLICATION

This application claims the benefit of Korean Patent Application No. 10-2005-0028516, filed on Apr. 6, 2005, in the Korean Intellectual Property Office, and the benefit of U.S. Provisional Patent Application No. 60/658,591, filed on Mar. 7, 2005, in the U.S. Patent and Trademark Office, the disclosures of which are incorporated herein in their entirety by reference.

### BACKGROUND OF THE INVENTION

1. Field of the Invention

The present invention relates to the protection of digital content, and more particularly, to a broadcast encryption method that encrypts digital content.

2. Description of the Related Art

Recently, transmission of digital content via a variety of communication mediums, such as the Internet, a terrestrial wave, a cable, or a satellite, has become ubiquitous, and the sale and rental of large-storage capacity recording media containing digital content, such as compact discs (CDs) or digital versatile discs (DVDs), has dramatically increased. Accordingly, more public attention has been drawn to digital rights management (DRM), which is a solution for protecting the copyright of digital content, and research has been vigorously carried out on various DRM techniques, particularly, an encryption broadcast method of encrypting digital content broadcasted with the aid of a recording medium, such as a CD or a DVD, or the Internet.

FIG. 1 is a diagram illustrating a conventional broadcast encryption method. Referring to FIG. 1, a content provider 11 encrypts content with a content key and broadcasts the encrypted content to a plurality of devices 131 through 134. In FIG. 1, the content encrypted with the content key is represented by E(CK, Content)(121).

The content provider 11 encrypts the content key with each of a plurality of device keys K1, K2, K3, . . . , Kn of the devices 131 through 134, thereby generating a plurality of encrypted content keys E(K1, CK), E(K2, CK), E(K3, CK), . . . , E(Kn, CK). Thereafter, the content provider 11 broadcasts an encrypted content key set {E(Ki, CK)} (122), including the encrypted content keys E(K1, CK), E(K2, CK), E(K3, CK), . . . , E(Kn, CK), to the devices 131 through 134.

The devices 131 through 134 attempt to decode {E(Ki, CK)}(122) using the respective sets of keys. If the devices 131 through 134 have at least one of the device keys used to encrypt the content key, they can decode the encrypted content key set {E(Ki, CK)}(122), thereby recovering the recovered content key. However, if the devices 131 through 134 do not have any of the device keys used to encrypt the content key, they cannot decode the encrypted content key set {E(Ki, CK)}(122).

If a device in the local network is revoked because its set of keys are exposed or because its user has not yet paid for the encrypted content E(CK, Content), the content provider 11 prevents the device from decoding the encrypted content E(CK, Content) by encoding the content key used for generating the encrypted content E(CK, Content) using keys other than the keys of the device and broadcasting the encrypted content key to the local network.

In the conventional broadcast encryption method, however, the larger the number of devices included in a local network, the larger the size of a key set allotted to each of the devices. In order to solve this problem, a key set is allotted to each of the devices in the local network using a tree comprised of a plurality of nodes.

FIG. 2 is a diagram of a tree used in the conventional broadcast encryption method of FIG. 1. Referring to FIG. 2, the tree is a binary tree comprised of four levels. Every node but the nodes (hereinafter referred to as leaf nodes) located at the lowermost level of the tree has two descendent nodes.

According to the conventional broadcast encryption method, a plurality of devices in a local network, i.e., devices 1 through 8, respectively correspond to the leaf nodes of the tree, and the devices 1 through 8 are allotted the keys of nodes on a path from the root node to the respective leaf nodes.

For example, keys K1, K2, K4, and K8 are located along a path from the root node to the leaf node corresponding to the device 1, and thus a key set including the keys K1, K2, K4, and K8 is allotted to the device 1.

FIG. 3 is a block diagram of a conventional broadcast encryption system. Referring to FIG. 3, the conventional broadcast encryption system includes a central server 31, a local server 32, and a plurality of devices 33 through 35. The central server 31 and the local server 32 are connected to the Internet. The local server 31 and the devices 33 through 35 are connected to a local network.

The central server 31 uses the tree of FIG. 2 and allots a key set to each of the devices 33 through 35 using the tree of FIG. 2. In addition, the central server 31 encrypts content using a content key and then broadcasts the encrypted content to the devices 33 through 35. Thereafter, the central server 31 encrypts the content key using a plurality of keys contained in the key set allotted to each of the devices 33 through 35 and broadcasts the encryption results to the devices 33 through 35.

The local server 32, like the central server 31, may provide content encrypted in the broadcast encryption scheme to the devices 33 through 35. For example, the local server 32 may obtain content in a content protection approach other than the broadcast encryption scheme and then transmit the obtained content to the devices 33 through 35 in the broadcast encryption scheme.

However, a tree actually used in broadcast encryption, unlike the tree of FIG. 2, may be very large according to a considerable number of devices. In addition, the local server 42 has a smaller storage capacity than the central server 41. Thus, the local server 42 may not be able to load the tree loaded in the central server 41. Accordingly, the local server 42 may not be able to transmit content to the devices 33 through 35 by using the conventional broadcast encryption method.

### SUMMARY OF THE INVENTION

The present invention provides a method and apparatus for transmitting content encrypted in a broadcast encryption scheme to a plurality of devices in a local network. The present invention also provides a computer-readable recording medium storing a computer program for executing the method.

According to an aspect of the present invention, there is provided a method of providing content encrypted in a predetermined encryption scheme to a plurality of devices in a local network. The method includes: storing a minimal number of keys needed by the devices to decode the encrypted content among a plurality of keys that can be used in the predetermined encryption scheme; and transmitting the stored keys to the devices.

According to an exemplary embodiment of the present invention, there is provided an apparatus for providing content encrypted in a predetermined encryption scheme to a plurality of devices in a local network. The apparatus includes: a storage unit which stores a minimal number of keys needed by the devices to decode the encrypted content among a plurality of keys that can be used in the predetermined encryption scheme; and a transmission unit which transmits the keys stored in the storage unit to the devices.

According to another exemplary embodiment of the present invention, there is provided a computer-readable recording medium storing a computer program for executing a method of providing content encrypted in a predetermined encryption scheme to a plurality of devices in a local network. The method includes: storing a minimal number of keys needed by the devices to decode the encrypted content among a plurality of keys that can be used in the predetermined encryption scheme; and transmitting the stored keys to the devices.

According to another exemplary embodiment of the present invention, there is provided a method of providing content encrypted in a predetermined encryption scheme to a plurality of devices in a local network. The method includes: storing a representative key that represents a minimal number of keys needed by the devices to decode the encrypted content among a plurality of keys that can be used in the predetermined encryption scheme; and transmitting the stored representative key to the devices.

According to another exemplary embodiment of the present invention, there is provided an apparatus for providing content encrypted in a predetermined encryption scheme to a plurality of devices in a local network. The apparatus includes: a storage unit which stores a representative key that represents a minimal number of keys needed by the devices to decode the encrypted content among a plurality of keys that can be used in the predetermined encryption scheme; and a transmission unit transmits the representative key stored in the storage unit to the devices.

According to another exemplary embodiment of the present invention, there is provided a computer-readable recording medium storing a computer program for executing a method of providing content encrypted in a predetermined encryption scheme to a plurality of devices in a local network. The method includes: storing a representative key that represents a minimal number of keys needed by the devices to decode the encrypted content among a plurality of keys that can be used in the predetermined encryption scheme; and transmitting the stored representative key to the devices.

### BRIEF DESCRIPTION OF THE DRAWINGS

The above and other features and aspects of the present invention will become more apparent by describing in detail exemplary embodiments thereof with reference to the attached drawings in which:

FIG. 1 is a diagram illustrating a conventional broadcast encryption method;

FIG. 2 is a diagram of an example of a tree used in the conventional broadcast encryption method;

FIG. 3 is a block diagram of a conventional broadcast encryption apparatus;

FIG. 4 is a block diagram of a broadcast encryption system according to an exemplary embodiment of the present invention;

FIG. 5 is a block diagram of an example of a local server of FIG. 4;

FIGS. 6A, 6B, and 6C are diagrams of examples of keys stored in a storage unit of FIG. 5;

FIG. 7 is a flowchart illustrating a method of providing content encrypted in a broadcast encryption scheme to a plurality of devices in a local network according to an exemplary embodiment of the present invention;

FIG. 8 is a flowchart illustrating a method of providing content encrypted in a broadcast encryption scheme to a plurality of devices in a local network according to another exemplary embodiment of the present invention;

FIG. 9 is a block diagram of another example of the local server of FIG. 4;

FIGS. 10A, 10B, and 10C are diagrams of examples of the keys stored in the storage unit of FIG. 5;

FIG. 11 is a flowchart illustrating a method of providing content encrypted in a broadcast encryption scheme to a plurality of devices in a local network according to another exemplary embodiment of the present invention; and

FIG. 12 is a flowchart illustrating a method of providing content encrypted in a broadcast encryption scheme to a plurality of devices in a local network according to another exemplary embodiment of the present invention.

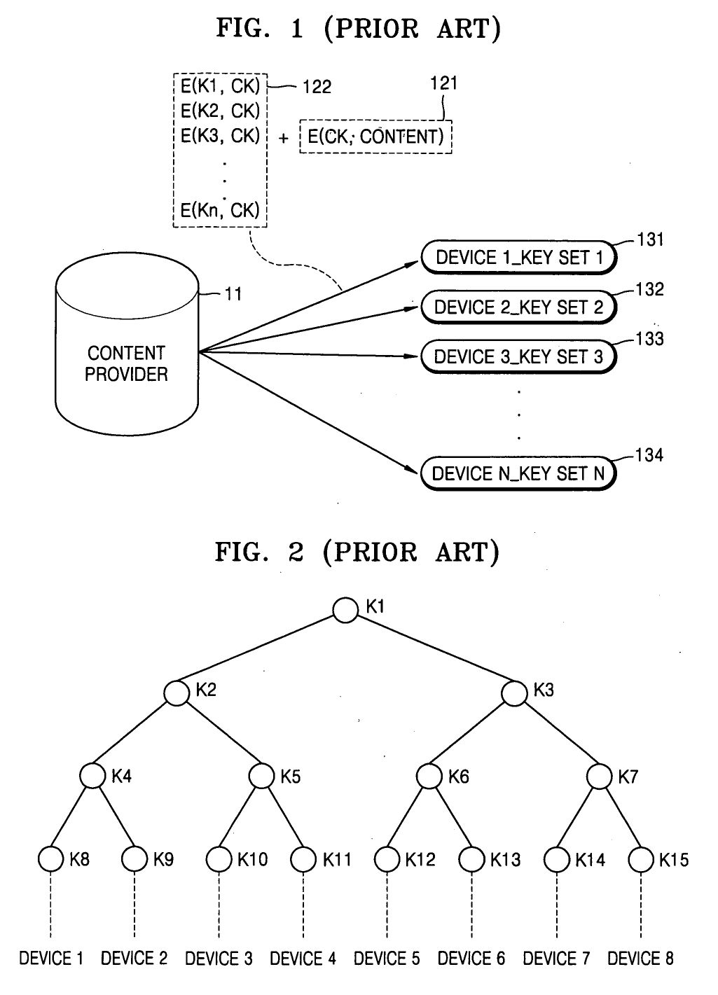

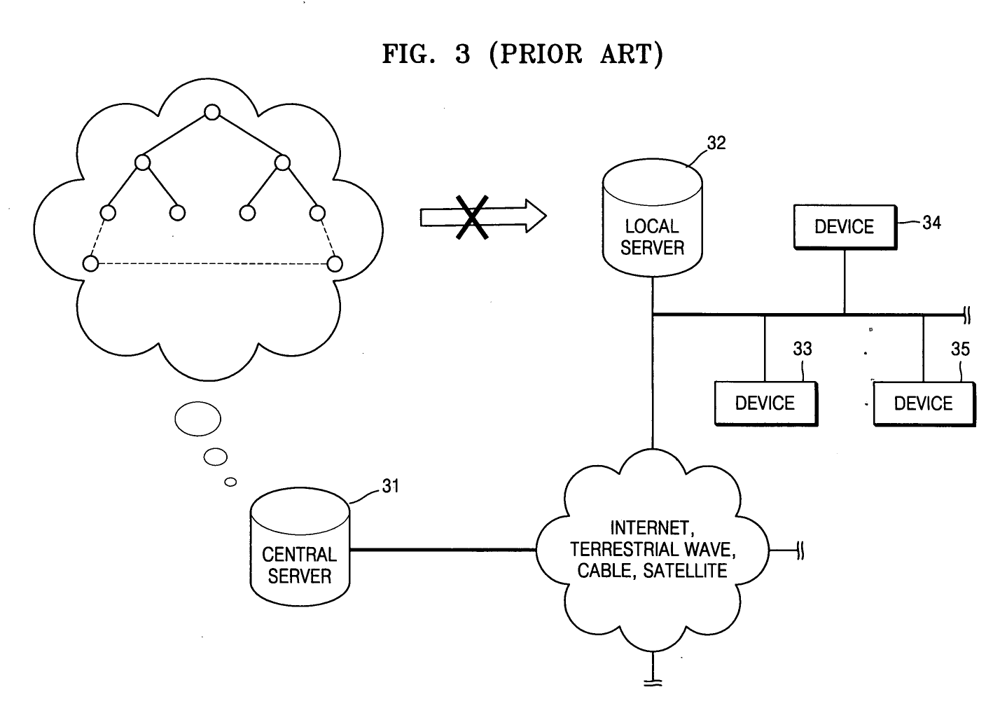

### DETAILED DESCRIPTION OF THE INVENTION

The present invention will now be described more fully with reference to the accompanying drawings in which exemplary embodiments of the invention are shown.

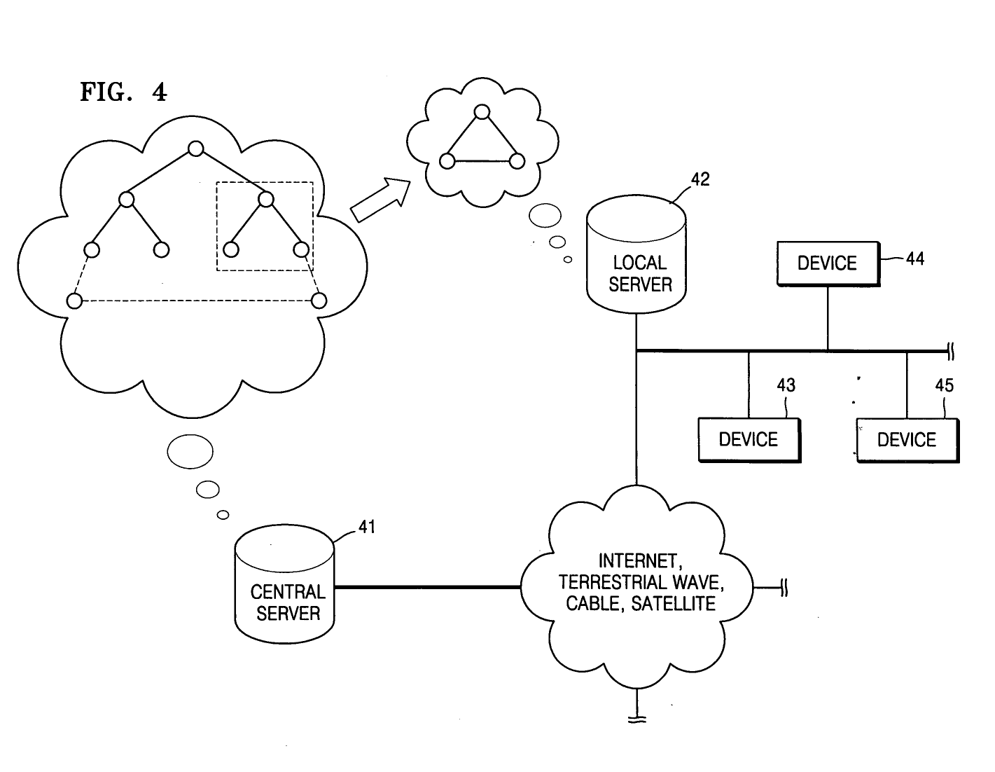

FIG. 4 is a block diagram of a broadcast encryption system according to an exemplary embodiment of the present invention. Referring to FIG. 4, the broadcast encryption system includes a central server 41, a local server 42, and devices 43 through 45. The broadcast encryption system broadcasts an encrypted content E(CK, Content) and a set of encrypted content keys {E(Ki, CK)} to the devices 43 through 45 in a broadcast encryption scheme.

The central server 41 may provide the encrypted content E(CK, Content) and the set of encrypted content keys {E(Ki, CK)} to the devices 43 through 45 via the Internet, a terrestrial wave, a cable, or a satellite in the same manner as in a conventional broadcast encryption system. The devices 43 through 45 decode the set of content keys {E(Ki, CK)}, thereby recovering an original content key. Thereafter, the devices 43 through 45 decode the encrypted content E(CK, Content) using the original content key, thereby recovering original content.

The local server 42, independently of the central server 42, provides the content E(CK, Content) and the set of encrypted content keys {E(Ki, CK)} to the devices 43 through 45 via a local network where the devices 43 through 45 are located in the broadcast encryption scheme. An example of the local network may be a home network.

The local server 42 has a smaller storage capacity than the central server 41 and thus may not be able to store all keys of a tree of the central server 41. In order to solve this problem, the local server 42 does not store all keys that could be used in the broadcast encryption method but rather only stores a minimal set of keys required by the devices 43 through 45 to decode the encrypted content E(CK, Content) in the broadcast encryption scheme.

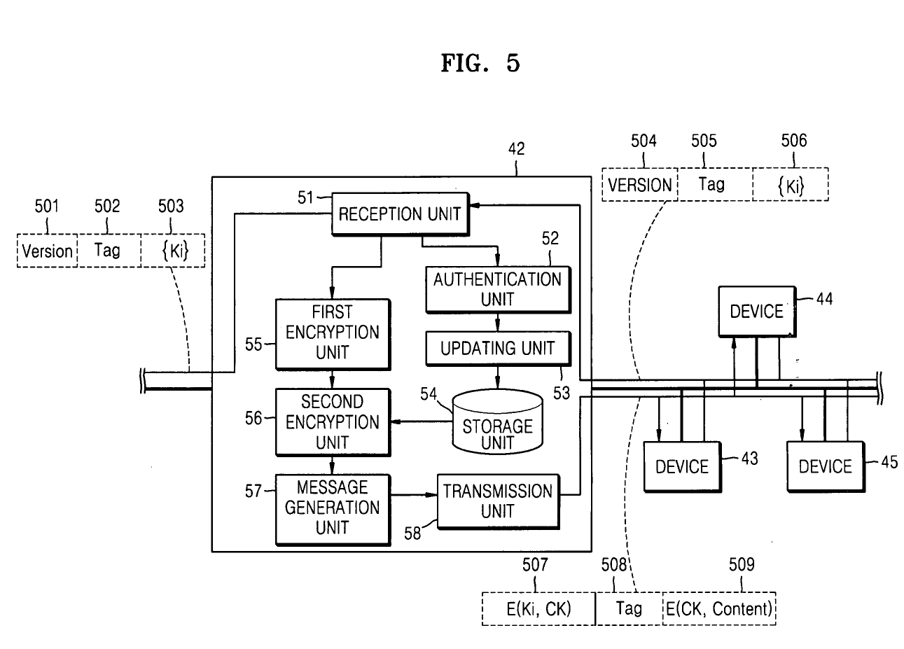

FIG. 5 is a block diagram of an example of the local server 42 of FIG. 4. Referring to FIG. 5, the local server 42 includes a reception unit 51, an authentication unit 52, an updating unit 53, a storage unit 54, a first encryption unit 55, a second encryption unit 56, a message generation unit 57, and a transmission unit 58.

The storage unit 54 stores only the minimal key set required by the devices 43 through 45 to decode the encrypted content E(CK, Content) in the broadcast encryption scheme. In detail, the minimal key set stored in the storage unit 54 includes all of the keys required by the devices 43 through 45 to decode the encrypted content E(CK, Content) except the keys that are revoked according to the broadcast encryption method.

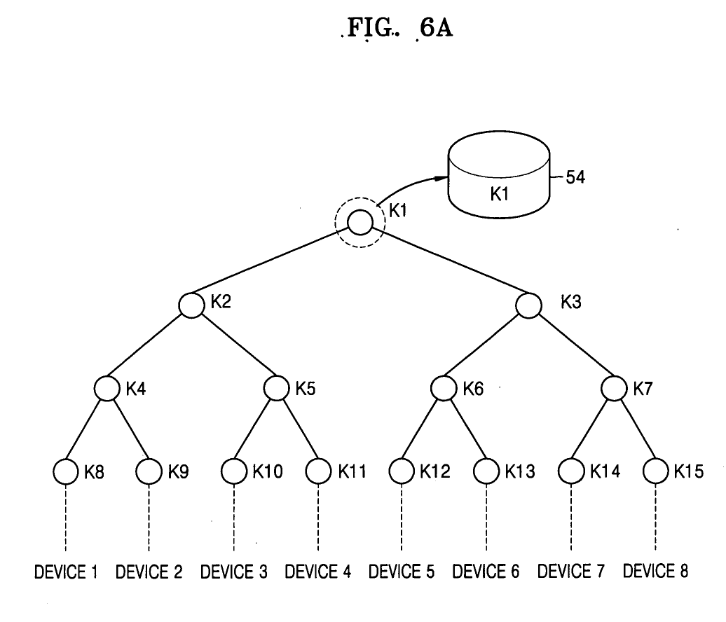

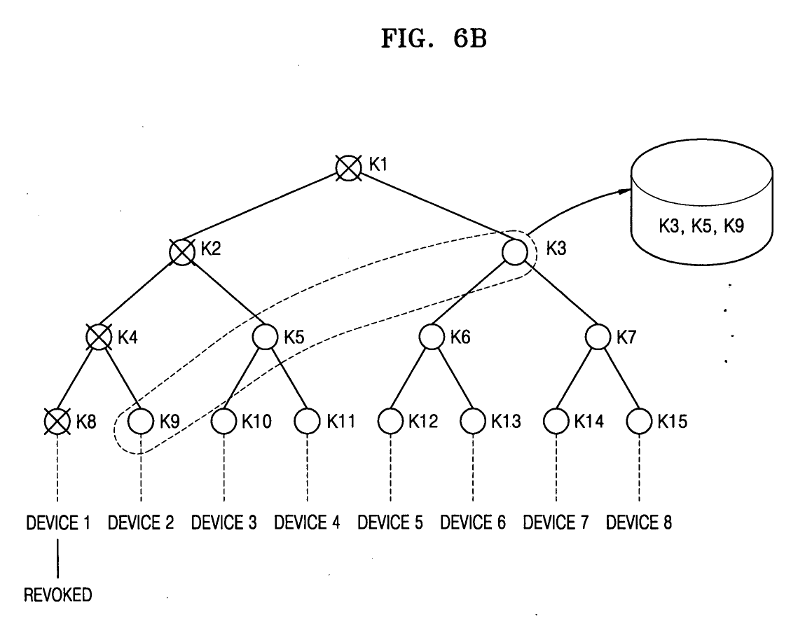

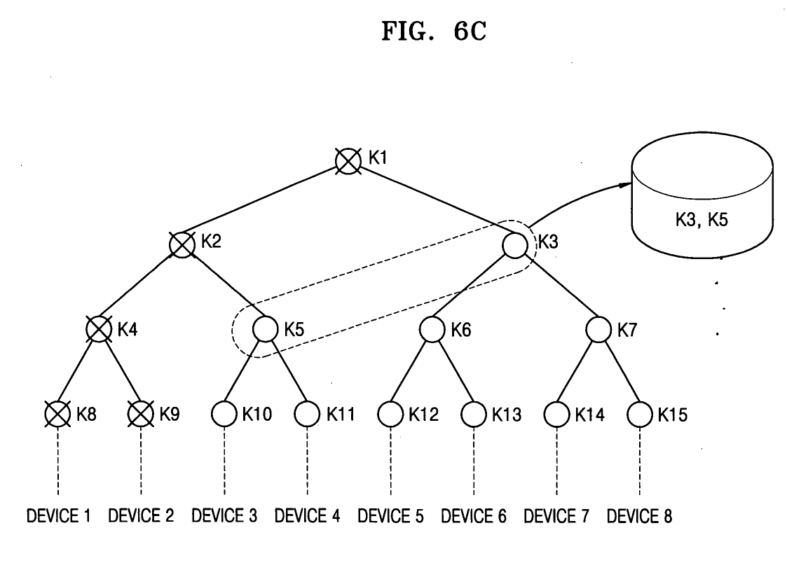

FIG. 6A is a diagram of a tree including a plurality of keys K1 through K15 for illustrating which of the keys K1 through K15 need to be stored in the storage unit 54 of FIG. 5 when none of the keys K1 through K15 are revoked. Referring to FIG. 6A, none of the keys K8 through K15 at leaf nodes of the tree, which correspond to devices 1 through 8, respectively, are revoked. In this case, all of the devices 1 through 8 can decode content encrypted in the broadcast encryption scheme by using the key K1 located at the root node of the tree. Therefore, the key K1 may be included in a minimal key set needed by the devices 43 through 45 to decode the encrypted content E(CK, Content), and thus, the key K1 is stored in the storage unit 54.

FIG. 6B is a diagram illustrating which of the keys K1 through K15 included in the tree of FIG. 6A need to be stored in the storage unit 54 of FIG. 5 when all of the keys corresponding to the device 1 are revoked. Referring to FIG. 6B, the keys K1, K2, K4, and K8 corresponding to the device 1 are all revoked. In this case, the devices 2 through 8 can decode content encrypted in the broadcast encryption scheme by using the key K3, K5, or K9. Therefore, the minimal key set required by the devices 43 through 45 to decode the encrypted content E(CK, Content) may include the keys K3, K5, and K9, in which case, the keys K3, K5, and K9 are stored in the storage unit 54.

FIG. 6C is a diagram illustrating which of the keys K1 through K15 included in the tree of FIG. 6A need to be stored in the storage unit 54 of FIG. 5 when all of the keys corresponding to the devices 1 and 2 are revoked. Referring to FIG. 6C, the keys K1, K2, K4, K8, and K9 corresponding to either the device 1 or 2 are all revoked. In this case, the devices 3 through 8 can decode content encrypted in the broadcast encryption scheme by using the key K3 or K5. Therefore, the minimal key set required by the devices 43 through 45 to decode the encrypted content E(CK, Content) may include the keys K3 and K5, in which case, the keys K3 and K5 are stored in the storage unit 54.

If none of the keys K1 through K15 are revoked when the manufacturer of the broadcast encryption system manufactures the local server 42, the storage unit 54 may be manufactured to store the key K1 therein. If all of the keys corresponding to the device 1 are revoked when the manufacturer of the broadcast encryption system manufactures the local server 42, the storage unit 54 may be manufactured to store the keys K3, K5, ad K9 therein. If all of the keys corresponding to the device 1 or 2 are revoked when the manufacturer of the broadcast encryption system manufactures the local server 42, the storage unit 54 may be manufactured to store the keys K3 and K5.

Referring to FIG. 5, the reception unit 51 receives an arbitrary content from outside the local network in which the devices 43 through 45 reside via, for example, the Internet, a terrestrial wave, a cable, or a satellite. The arbitrary content received by the reception unit 51 may or may not include version information 501 regarding the version of a plurality of keys 503 used for generating the set of encrypted content keys {E(Ki, CK)}. When the received arbitrary content is generated, a tag 502 in which information regarding the keys 503 used for generating the set of encrypted content keys {E(Ki, CK)} is recorded, and the keys 503 used for generating the set of encrypted content keys {E(Ki, CK)}, depending on how the updating unit 53 updates the keys, are stored in the storage unit 54.

The authentication unit 52 authenticates a plurality of keys of a device that has entered the local network or a plurality of keys included in the arbitrary content received by the reception unit 51. In detail, the authentication unit 52 may authenticate the keys of the device that has entered the local network with reference to a device identifier of the device that has entered the local network and a tag possessed by the local server 42 or may authenticate the keys included in the arbitrary content received by the reception unit 51 with reference to a content identifier of the received arbitrary content and the tag processed by the local server 42 depending on how the updating unit 53 updates the keys stored in the storage unit 54.

Different devices or different contents have different sets of keys from one another. Therefore, the authentication unit 52 determines which keys each of the different devices or contents possess with reference to a device identifier, unique to each device or a content identifier, unique to each content. In other words, if some of a plurality of keys corresponding to a predetermined device identifier or a predetermined content identifier are included in the tag 502 or a tag 505, the authentication unit 52 outputs all of the keys (503) of a device corresponding to the predetermined device identifier or all of the keys included in a content corresponding to the predetermined content identifier. However, if none of the keys corresponding to the predetermined device identifier or the predetermined content identifier are included in the tag 502 or 505, the authentication unit 52 outputs a message indicating that all of the keys of the device corresponding to the predetermined device identifier or stored in the content corresponding to the predetermined content identifier are revoked.

The updating unit 53 updates the keys stored in the storage unit 54 depending on whether the keys stored in the storage unit 54 are revoked. For example, if none of the keys K1 through K15 were revoked when the manufacturer of the broadcast encryption system manufactured the local server 42 and, later, the keys corresponding to the device 1 are revoked as illustrated in FIG. 6B, then the updating unit 53 updates the key K1 stored in the storage unit 54 with the keys K3, K5, and K9. Likewise, if the keys corresponding to the device 1 were revoked when the manufacturer of the broadcast encryption system manufactured the local server 42 and, later, the keys corresponding to the device 2 are also revoked as illustrated in FIG. 6C, then the updating unit 53 updates the keys K3, K5, and K9 stored in the storage unit 54 with the keys K3 and K5.

In detail, the updating unit 53 compares the keys output by the authentication unit 52 with the keys stored in the storage unit 54 and decides whether to update the keys stored in the storage unit 54 based on the comparison results. The updating unit 53 updates the keys stored in the storage unit 54 in one of the following two approaches.

In the first approach, the updating unit 54 updates the keys stored in the storage unit 54 with a plurality of keys of a device that has entered the local network in which the devices 43 through 45 reside if the version of the keys of the device that has entered the local network is higher than the version of the keys stored in the storage unit 54.

For example, if the key K1 having version 1 is stored in the storage unit 54 and the device that has entered the local network possesses the keys K3, K5, and K9 having version 2, the updating unit 53 updates the key K1 stored in the storage unit 54 with the keys K3, K5, and K9. In this case, it appears that none of the keys K1 through K15 were revoked when the manufacturer of the broadcast encryption system manufactured the local server 42 and that later the keys corresponding to the device 1 were revoked when the manufacturer of the broadcast encryption system manufactured the device that has entered the local network.

In the first approach, the manufacturer of the broadcast encryption system must determine whether each of the keys corresponding to the devices 43 through 45 is revoked before manufacturing the devices 43 through 45. In other words, the manufacturer of the broadcast encryption system must manufacture the storage device 54 to store only the keys that are not yet revoked when manufacturing the devices 43 through 45.

In the second approach, the updating unit 53 updates the keys stored in the storage unit 54 with a plurality of keys stored in the arbitrary content received by the reception unit 51 if the version of the keys contained in the received arbitrary content is higher than the version of the keys stored in the storage unit 54.

For example, if the key K1 is stored in the storage unit 54 and has version 1 and the arbitrary content received by the reception unit 51 possesses the keys K3, K5, and K9 having version 2, the updating unit 53 updates the key K1 stored in the storage unit 54 with the keys K3, K5, and K9. In this case, it appears that none of the keys K1 through K15 were revoked when the manufacturer of the broadcast encryption system manufactured the local server 42 and that the keys corresponding to the device 1 are revoked when the manufacturer of the broadcast encryption system provides the arbitrary content to the reception unit 51.

Therefore, in the second approach, the manufacturer of the broadcast encryption system must determine whether each of the keys corresponding to the devices 43 through 45 is revoked before providing the arbitrary content. In other words, the manufacturer of the broadcast encryption system must transmit content containing only the keys that are not yet revoked.

The first encryption unit 55 encrypts the arbitrary content received by the reception unit 51 using a predetermined content key, thereby generating the encrypted content E(CK, Content). The content key used for encrypting the received arbitrary content is stored in local server 42 at the manufacturer so that it can be protected afterwards from an external attack.

The second encryption unit 56 encrypts the content key used by the first encryption unit 55 for encrypting the received arbitrary content using the keys stored in the storage unit 52, thereby generating the set of encrypted content keys {E(Ki, CK)}.

The message generation unit 57 generates a message comprising a header 507, a tag 508, and a payload 509. The set of encrypted content keys {E(Ki, CK)} is recorded in the header 507, information regarding the set of encrypted content keys {E(Ki, CK)} is recorded in the tag 508, and the encrypted content E(CK, Content) obtained by the first encryption unit 55 is recorded in the payload 509.

The transmission unit 58 broadcasts the message generated by the message generation unit 57 to the devices 43 through 45 in the local network. In other words, the transmission unit 58 broadcasts the message comprised of the header 507 in which the set of encrypted content keys {E(Ki, CK)} is recorded, the tag 508 in which the information regarding the set of encrypted content keys {E(Ki, CK)} recorded in the header 507 is recorded, and the payload 509 in which the encrypted content E(CK, Content) obtained by the first encryption unit 55 is recorded to the devices 43 through 45 in the local network.

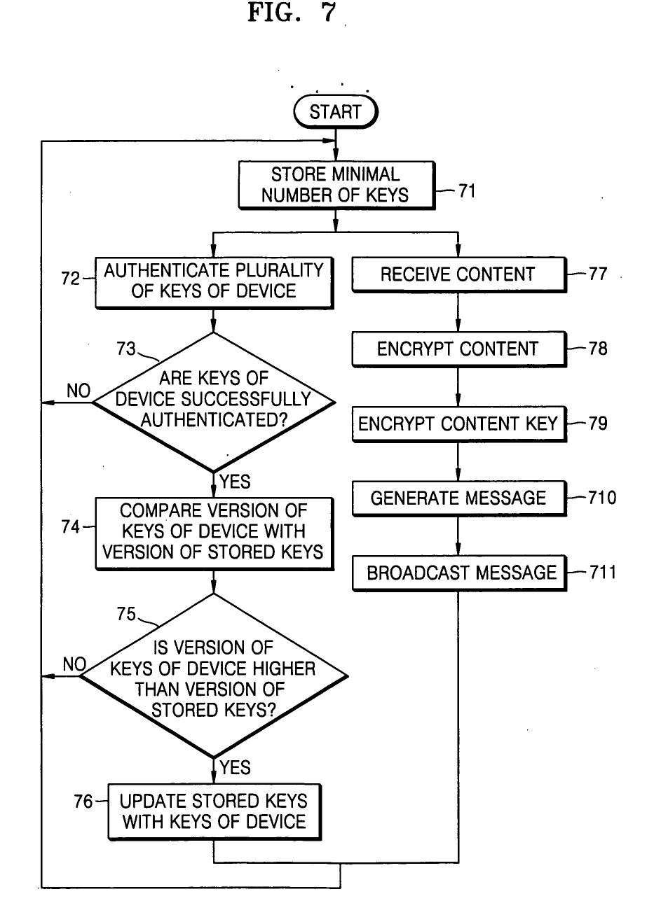

FIG. 7 is a flowchart illustrating a method of providing content encrypted in a broadcast encryption scheme to a plurality of devices in a local network according to an exemplary embodiment of the present invention. The method of FIG. 7 is performed by the local server 42 of FIG. 5.

Referring to FIG. 7, in operation 71, the local server 42 stores one or more keys included in a minimal key set needed by the devices 43 through 45 to decode encrypted content E(CK, Content) in the broadcast encryption scheme, among a plurality of keys used in the broadcast encryption method at a given moment of time. The given moment of time may be the time when the local server 42 is manufactured or the time when the local server 42 is updated.

In operation 72, the local server 42 authenticates a plurality of keys possessed by a device that has entered a local network in which the devices 43 through 45 reside.

In operations 73 and 74, if the keys of the device that has entered the local network are successfully authenticated in operation 72, the local server 42 compares the version of the keys of the device that has entered the local network with the version of the keys stored therein in operation 71.

In operations 75 and 76, if the version of the keys of the device that has entered the local network is higher than the version of the keys stored in the local network 42 in operation 71, the local server 42 updates the keys stored therein in operation 71 with the keys of the device that has entered the local network.

In operation 77, the local server 42 receives an arbitrary content from outside the local network.

In operation 78, the local server 42 generates the encrypted content E(CK, Content) by encrypting the arbitrary content received in operation 77 using a content key.

In operation 79, the local server 42 encrypts the content key used in operation 78 using the keys stored therein in operation 71, thereby generating a set of encrypted content keys {E(Ki, CK)}.

In operation 710, the local server 42 generates a message comprising a header 507 in which the set of encrypted content keys {E(Ki, CK)} are recorded, a tag 508 in which information regarding the keys used for generating the set of encrypted content keys {E(Ki, CK)} is recorded, and a payload 509 in which the encrypted content E(CK, Content) is recorded.

In operation 711, the local server 42 broadcasts the message generated in operation 710 to all of the devices currently residing in the local network.

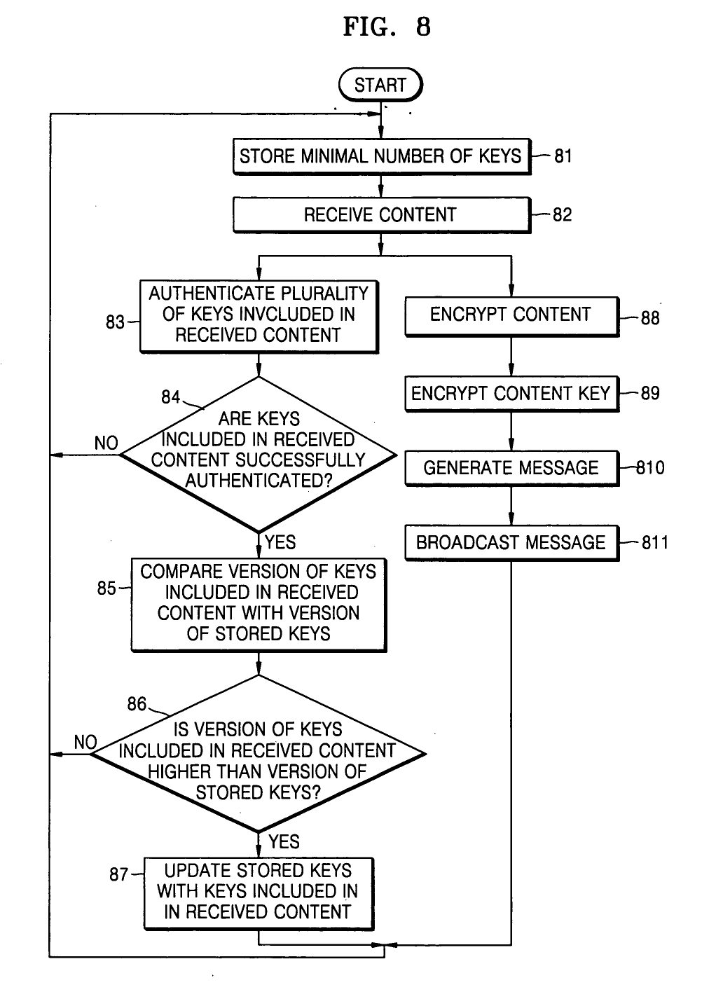

FIG. 8 is a flowchart illustrating a method of providing content encrypted in a broadcast encryption scheme to a plurality of devices in a local network according to an exemplary embodiment of the present invention. The method of FIG. 8 is performed by the local server 42 of FIG. 5.

Referring to FIG. 8, in operation 81; the local server 42 stores one or more keys included in a minimal key set needed by the devices 43 through 45 to decode encrypted content E(CK, Content) in the broadcast encryption scheme, among a plurality of keys used in the broadcast encryption method at a given moment of time. The given moment of time may be the time when the local server 42 is manufactured or the time when the local server 42 is updated.

In operation 82, the local server 42 receives an arbitrary content from outside a local network in which the devices 43 through 45 reside. The arbitrary content received in operation 82 includes version information 501 specifying the version of a plurality of keys 503 used for generating a set of encrypted keys {E(Ki, CK)} when version information 501 is generated, a tag 502 in which information regarding the keys 503 used for generating the set of encrypted keys {E(Ki, CK)} is recorded, and the keys 503 used for generating the set of encrypted keys {E(Ki, CK)}.

In operation 83, the local server 42 authenticates a plurality of keys contained in the received arbitrary content.

In operations 84 and 85, if the keys stored in the received arbitrary content are successfully authenticated in operation 83, the local server 42 compares the version of the keys stored in the received arbitrary content with the version of the keys stored therein in operation 81.

In operations 86 and 87, if the version of the keys contained in the received arbitrary content is higher than the version of the keys stored in the local server 42 in operation 81, the local server 42 updates the keys stored therein in operation 81 with the keys contained in the received arbitrary content.

In operation 88, the local server 42 generates encrypted content E(CK, Content) by encrypting the received arbitrary content using a content key.

In operation 89, the local server 42 encrypts the content key used in operation 88 using the keys stored therein in operation 81, thereby generating a set of encrypted keys {E(Ki, CK)}.

In operation 810, the local server 42 generates a message comprising a header 507 in which the set of encrypted content keys {E(Ki, CK)} are recorded, a tag 508 in which information regarding the keys used for generating the set of encrypted content keys {E(Ki, CK)} is recorded, and a payload 509 in which the encrypted content E(CK, Content) is recorded, as shown in FIG. 5.

In operation 811, the local server 42 broadcasts the message generated in operation 710 to all of the devices 43 through 45 in the local network.

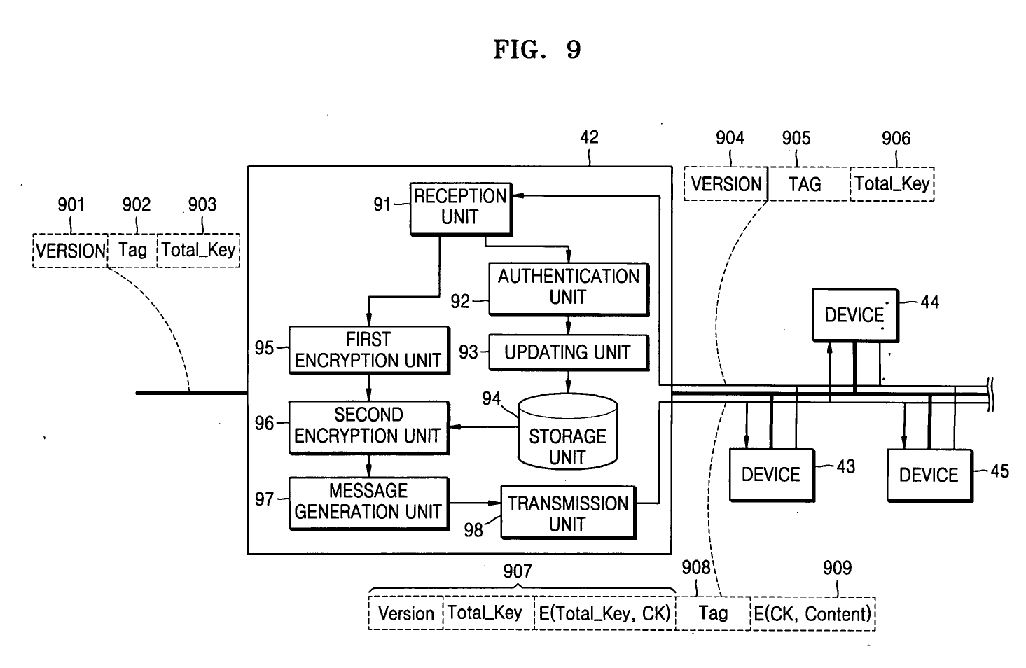

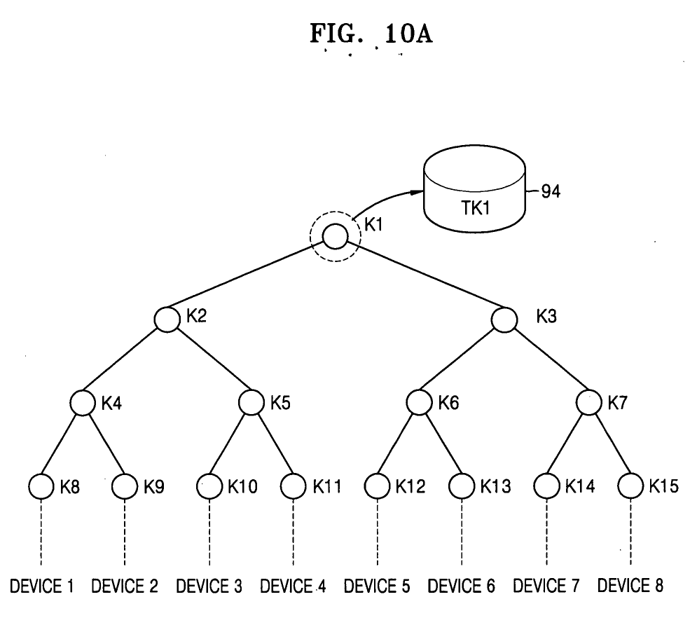

FIG. 9 is a block diagram of another example of the local server 42 of FIG. 4. Referring to FIG. 9, the local server 42 includes a reception unit 91, an authentication unit 92, an updating unit 93, a storage unit 94, a first encryption unit 95, a second encryption unit 96, a message generation unit 97, and a transmission unit 98.

When the number of devices revoked increases, the local server 42 of FIG. 5 may have to store a considerable number of keys even though it attempts to store only a minimal set of keys required by the devices to decode encrypted content. The more keys the local server 42 of FIG. 5 stores, the more times the local server 42 of FIG. 5 needs to encrypt a content key and the more times the devices 43 through 45 need to decode the encrypted content key.

Therefore, the local server 42 of FIG. 9 stores only a representative key that represents a minimal set of keys, among a plurality of keys used in a broadcast encryption method, required by the devices 43 through 45 to decode encrypted content E(CK, Content) in the broadcast encryption scheme.

In detail, the storage unit 94 stores only a representative key that represents a minimal key set needed by the devices 43 through 45 to decode encrypted content E(CK, Content) in a broadcast encryption scheme, and the minimal set of keys are selected from among the keys used in the broadcast encryption method that are yet to be revoked.

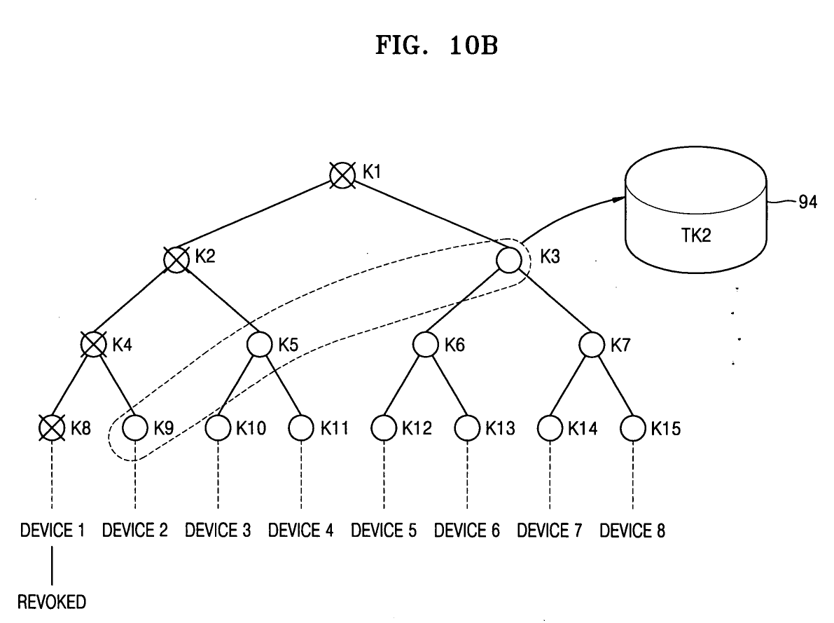

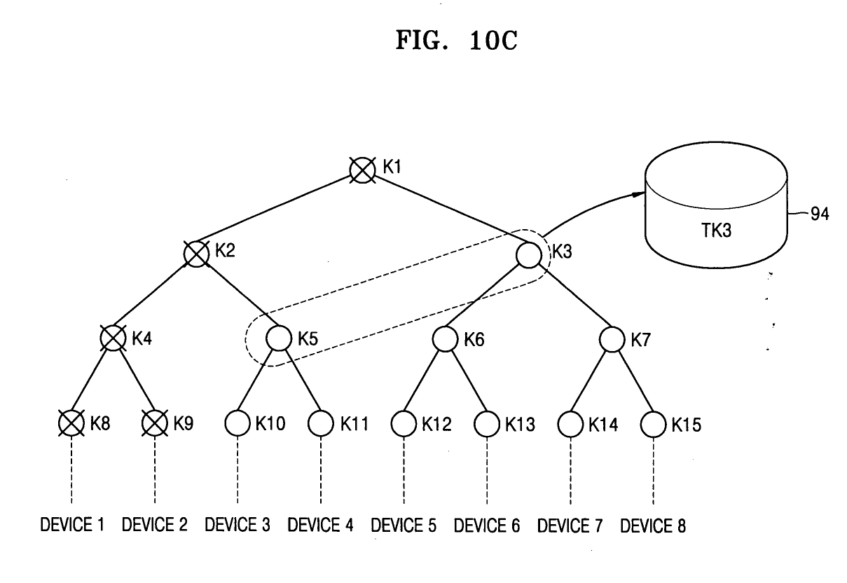

FIG. 10A is a diagram illustrating a tree including a plurality of keys K1 through K15 to indicate what representative key needs to be stored in the storage unit 54 of FIG. 9 when none of the keys K1 through K15 are revoked. Referring to FIG. 10A, none of the keys K1 through K15 allotted to leaf nodes of the tree are revoked yet. In this case, all of the devices 1 through 8 can decode content encrypted in the broadcast encryption scheme by using the key K1 located at the root node of the tree. Accordingly, the key K1 may be included in a minimal key set needed by the devices 43 through 45 to decode the encrypted content E(CK, Content), and thus, a representative key TK1 representing the key K1 is stored in the storage unit 94.

FIG. 10B is a diagram illustrating what representative key needs to be stored in the local server 43 of FIG. 9 when all of the keys corresponding to the device 1 are revoked. Referring to FIG. 10B, the keys corresponding to the device 1, i.e., the keys K1, K2, K4, and K8, are revoked. In this case, the devices 2 through 8 can decode content encrypted in the broadcast encryption scheme by using the keys K3, K5, and K9. Accordingly, the key K3, K5, and K9 may be included in the minimal key set needed by the devices 43 through 45 to decode the encrypted content E(CK, Content), and thus, a representative key TK2 representing the keys K3, K5, and K9 is stored in the storage unit 94.

FIG. 10C is a diagram illustrating what representative key needs to be stored in the local server 43 of FIG. 9 when all of the keys corresponding to the devices 1 and 2 are revoked. Referring to FIG. 10C, all of the keys corresponding to the devices 1 and 2, i.e., the keys K1, K2, K4, K8, and K9, are revoked. In this case, the devices 3 through 8 can decode content encrypted in the broadcast encryption scheme by using the keys K3 and K5. Therefore, the keys K3 and K5 may be included in the minimal key set needed by the devices 43 through 45 to decode the encrypted content E(CK, Content), and thus, a representative key TK3 representing the keys K3 and K5 is stored in the storage unit 94.

If none of the keys K1 through K15 are revoked when the manufacturer of the broadcast encryption system manufactures the local server 42, the storage unit 54 may be manufactured to store the representative key TK1 therein. If all of the keys corresponding to the device 1 are revoked when the manufacturer of the broadcast encryption system manufactures the local server 42, the storage unit 54 may be manufactured to store the representative key TK2 therein. If all of the keys corresponding to the device 1 or 2 are revoked when the manufacturer of the broadcast encryption system manufactures the local server 42, the storage unit 54 may be manufactured to store the representative key TK3.

Referring to FIG. 9, the reception unit 91 receives an arbitrary content from outside the local network in which the devices 43 through 45 reside via, for example, the Internet, a terrestrial wave, a cable, or a satellite. The arbitrary content received by the reception unit 91 may or may not include version information 901 regarding the version of a plurality of keys 903 used for generating the set of encrypted content keys {E(Ki, CK)} when the received arbitrary content is generated, a tag 902 in which information regarding the keys 903 used for generating the set of encrypted content keys {E(Ki, CK)}, and the keys 903 used for generating the set of encrypted content keys {E(Ki, CK)} depending on how the updating unit 93 updates the keys stored in the storage unit 94.

The authentication unit 92 authenticates a plurality of keys of a device that has entered the local network or a plurality of keys included in the arbitrary content received by the reception unit 91. In detail, the authentication unit 92 may authenticate the keys of the device that has entered the local network with reference to a device identifier of the device that has entered the local network and a tag of the local server 42 or may authenticate the keys included in the arbitrary content received by the reception unit 91 with reference to a content identifier of the received arbitrary content and the tag of the local server 42 depending on how the updating unit 93 updates the keys stored in the storage unit 94.

Different devices or different contents have different sets of keys from one another. Therefore, the authentication unit 92 determines what keys each of the different devices or contents possesses with reference to a device identifier of each of the different devices or a content identifier of each of the different contents. In other words, if some of a plurality of keys corresponding to a predetermined device identifier or a predetermined content identifier are included in a tag of the local server 42, the authentication unit 92 outputs all of the keys of a device corresponding to the predetermined device identifier or all of the keys contained in a content corresponding to the predetermined content identifier. However, if none of the keys corresponding to the predetermined device identifier or the predetermined content identifier are included in the tag of the local server 42, the authentication unit 52 outputs a message indicating that all of the keys of the device corresponding to the predetermined device identifier or contained in the content corresponding to the predetermined content identifier are revoked.

The updating unit 93 updates the representative key stored in the storage unit 54 depending on whether the keys stored in the storage unit 54 are revoked. For example, if none of the keys K1 through K15 are revoked when the manufacturer of the broadcast encryption system manufactures the local server 42 and, later, the keys corresponding to the device 1 are revoked as illustrated in FIG. 10B, then the updating unit 53 updates the representative key TK1 stored in the storage unit 54 with the representative key TK2. Likewise, if the keys corresponding to the device 1 are revoked when the manufacturer of the broadcast encryption system manufactures the local server 42 and, later, the keys corresponding to the device 2 are also revoked as illustrated in FIG. 10C, then the updating unit 93 updates the representative key TK2 stored in the storage unit 54 with the representative key TK3.

In detail, the updating unit 93 compares the representative key output by the authentication unit 92 with the representative key stored in the storage unit 94 and decides whether to update the representative key stored in the storage unit 94 based on the comparison results. The updating unit 93 updates the representative key stored in the storage unit 94 in one of the following two approaches.

In the first approach, the updating unit 94 updates the representative key stored in the storage unit 54 with a representative key of a device that has entered the local network in which the devices 43 through 45 reside if the version of the representative key of the device that has entered the local network is higher than the version of the representative key stored in the storage unit 94.

For example, if the representative key TK1 having version 1 is stored in the storage unit 94 and the device that has entered the local network possesses the representative key TK2 having version 2, then the updating unit 93 updates the representative key TK1 stored in the storage unit 94 with the representative key TK2. In this case, it appears that none of the keys K1 through K15 were revoked when the manufacturer of the broadcast encryption system manufactured the local server 42 and, later, the keys corresponding to the device 1 are revoked when the manufacturer of the broadcast encryption system manufactures the device that has entered the local network.

In the first approach, the manufacturer of the broadcast encryption system must determine whether each of the keys corresponding to the devices 43 through 45 is revoked before manufacturing the devices 43 through 45. In other words, the manufacturer of the broadcast encryption system must manufacture the storage device 94 to store a representative key representing only the keys that are not yet revoked when manufacturing the devices 43 through 45.

In the second approach, the updating unit 93 updates the representative key stored in the storage unit 94 with a representative key included in the arbitrary content received by the reception unit 91 if the version of the representative key included in the received arbitrary content is higher than the version of the representative key stored in the storage unit 94.

For example, if the representative key TK1 having version 1 is stored in the storage unit 94 and the arbitrary content received by the reception unit 91 possesses the representative key TK2 having version 2, the updating unit 93 updates the representative key TK1 stored in the storage unit 94 with the representative key TK2. In this case, it appears that none of the keys K1 through K15 were revoked when the manufacturer of the broadcast encryption system manufactured the local server 42 and the keys corresponding to the device 1 are revoked when the manufacturer of the broadcast encryption system provides the arbitrary content to the reception unit 91.

Therefore, in the second approach, the manufacturer of the broadcast encryption system must determine whether each of the keys corresponding to the devices 43 through 45 is revoked before providing the arbitrary content. In other words, the manufacturer of the broadcast encryption system must transmit content containing a representative key representing the keys that are not yet revoked.

The first encryption unit 95 encrypts the arbitrary content received by the reception unit 91 using a predetermined content key, thereby generating the encrypted content E(CK, Content). The content key used for encrypting the received arbitrary content is stored in local server 42 at the manufacturer so that it can be protected afterwards from an external attack.

The second encryption unit 96 encrypts the content key used by the first encryption unit 95 for encrypting the received arbitrary content using the representative key stored in the storage unit 92, thereby generating an encrypted content key E(Total_Key, CK).

The message generation unit 97 generates a message comprising a header 907, a tag 908, and a payload 909. Version information specifying the version of the representative key used by the second encryption unit 96 for generating encrypted content key E(Total_Key, CK), the representative key used by the second encryption unit 96 for generating encrypted content key E(Total_Key, CK), and the encrypted content key E(Total_Key, CK) are recorded in the header 907, information regarding the encrypted content key E(Total_Key, CK) is recorded in the tag 908, and the encrypted content E(CK, Content) obtained by the first encryption unit 95 is recorded in the payload 909.

The transmission unit 98 broadcasts the message generated by the message generation unit 97 to the devices 43 through 45 in the local network. In other words, the transmission unit 98 broadcasts the message comprising: the header 907 in which the version information specifying the version of the representative key used by the second encryption unit 96 for generating encrypted content key E(Total_Key, CK), the representative key used by the second encryption unit 96 for generating encrypted content key E(Total_Key, CK), and the encrypted content key E(Total_Key, CK) are recorded; the tag 908 in which the information regarding the encrypted content key E(Total_Key, CK) is recorded; and the payload 909 in which the encrypted content E(CK, Content) obtained by the first encryption unit 95 is recorded to the devices 43 through 45 in the local network.

In the present embodiment, the devices 43 through 45 cannot decode the encrypted content key E(Total_Key, CK) without knowing about the representative key contained in the message broadcasted by the local server 42. Therefore, devices 43 through 45 update their respective representative keys with the representative key contained in the message broadcasted by the local server 42 if the version of the representative key contained in the message broadcasted by the local server 42 is higher than the version of their respective representative keys.

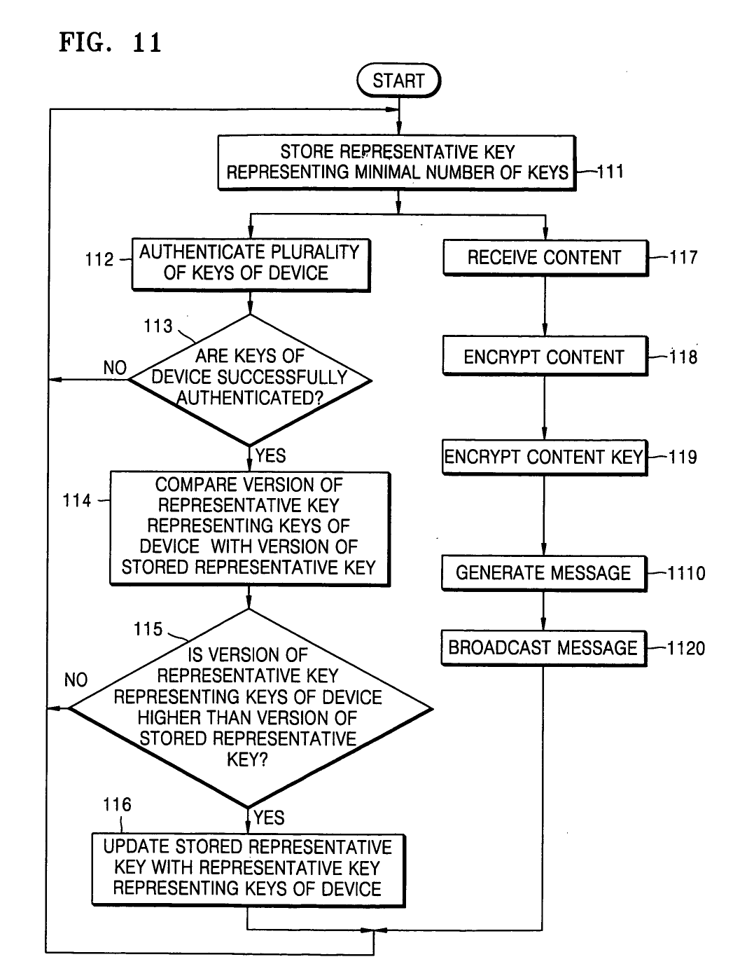

FIG. 11 is a flowchart illustrating a method of providing content encrypted in a broadcast encryption scheme to a plurality of devices residing in a local network according to an exemplary embodiment of the present invention. The method of providing content encrypted in a broadcast encryption scheme to a plurality of devices in a local network of FIG. 11 is performed by the local server 42 of FIG. 9.

Referring to FIG. 11, in operation 111, the local server 42 stores a representative key representing one or more keys included in a minimal key set needed by the devices 43 through 45 to decode encrypted content E(CK, Content) in the broadcast encryption scheme, among a plurality of keys used in the broadcast encryption method at a given moment of time. The given moment of time may be the time when the local server 42 is manufactured or the time when the local server 42 is updated.

In operation 112, the local server 42 authenticates a representative key representing a plurality of keys possessed by a device that has entered a local network in which the devices 43 through 45 reside.

In operations 113 and 114, if the representative key of the device that has entered the local network is successfully authenticated in operation 72, the local server 42 compares the version of the representative key of the device that has entered the local network with the version of the representative key stored therein in operation 111.

In operations 115 and 116, if the version of the representative key of the device that has entered the local network is higher than the version of the representative key stored in the local network 42 in operation 111, the local server 42 updates the representative key stored therein in operation 111 with the representative key of the device that has entered the local network.

In operation 117, the local server 42 receives an arbitrary content from outside the local network.

In operation 118, the local server 42 generates the encrypted content E(CK, Content) by encrypting the arbitrary content received in operation 117 using a content key.

In operation 119, the local server 42 encrypts the content key used in operation 118 using the representative key stored therein in operation 111, thereby generating an encrypted content key E(Total_Key, CK).

In operation 1110, the local server 42 generates a message comprising: a header 907 in which version information specifying the version of the representative key used in operation 119, the representative key used in operation 119, and the encrypted content key E(Total_Key, CK) are recorded; a tag 908 in which information regarding the encrypted content key E(Total_Key, CK) used in operation 119 is recorded; and a payload 909 in which the encrypted content E(CK, Content) is recorded.

In operation 1120, the local server 42 broadcasts the message generated in operation 1110 to all of the devices currently residing in the local network.

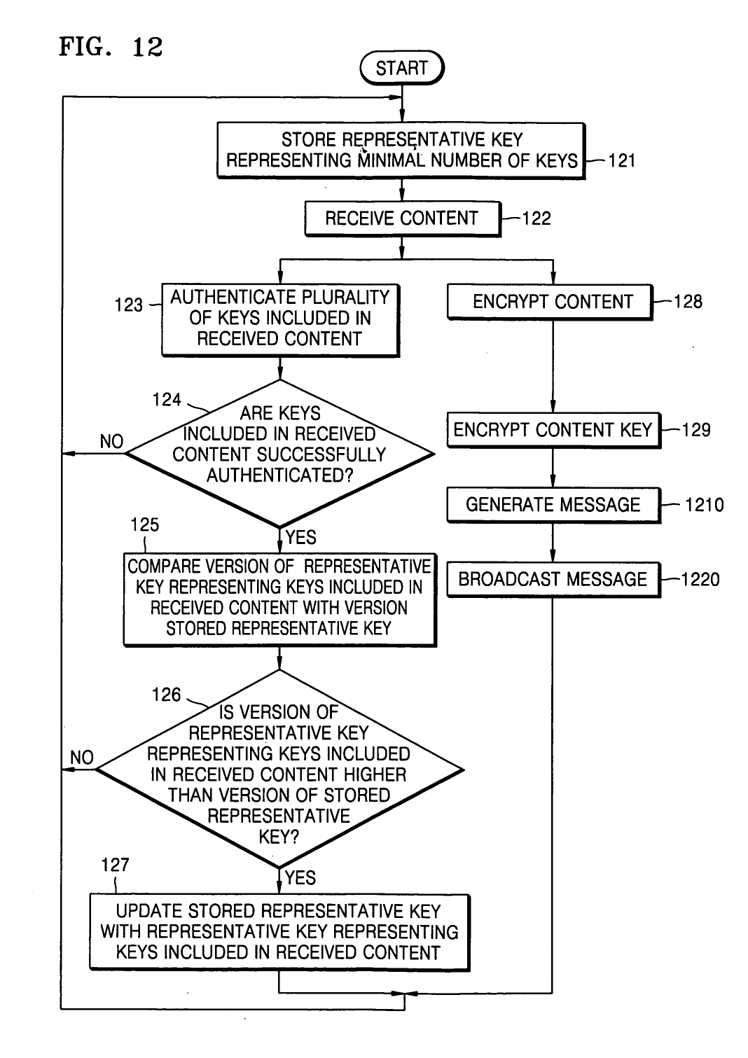

FIG. 12 is a flowchart illustrating a method of providing content encrypted in a broadcast encryption scheme to a plurality of devices in a local network according to an exemplary embodiment of the present invention. The method of providing content encrypted in a broadcast encryption scheme to a plurality of devices in a local network of FIG. 12 is performed by the local server 42 of FIG. 9.

Referring to FIG. 12, in operation 121, the local server 42 stores a representative key representing one or more keys included in a minimal key set needed by the devices 43 through 45 to decode encrypted content E(CK, Content) in the broadcast encryption scheme, among a plurality of keys used in the broadcast encryption method at a given moment of time. The given moment of time may be the time when the local server 42 is manufactured or the time when the local server 42 is updated.

In operation 122, the local server 42 receives an arbitrary content from outside a local network in which the devices 43 through 45 reside. The arbitrary content received in operation 122 includes version information 901 specifying the version of a plurality of keys 903 used for generating a set of encrypted keys {E(Ki, CK)} when it is generated, a tag 902 in which information regarding the keys 903 used for generating the set of encrypted keys {E(Ki, CK)} is recorded, and the keys 903 used for generating the set of encrypted keys {E(Ki, CK)}.

In operation 123, the local server 42 authenticates a plurality of keys contained in the received arbitrary content.

In operations 124 and 125, if the keys contained in the received arbitrary content are successfully authenticated in operation 123, the local server 42 compares the version of a representative key representing the keys contained in the received arbitrary content with the version of the representative key stored therein in operation 121.

In operations 126 and 127, if the version of the representative key of the received arbitrary content is higher than the version of the representative key stored in the local server 42 in operation 121, the local server 42 updates the representative key stored therein in operation 121 with the representative key of the received arbitrary content.

In operation 128, the local server 42 generates encrypted content E(CK, Content) by encrypting the received arbitrary content using a content key.

In operation 129, the local server 42 encrypts the content key used in operation 88 using the representative key stored therein in operation 121, thereby generating an encrypted content key E(Total_Key, CK).

In operation 1210, the local server 42 generates a message comprised of: a header 907 in which version information specifying the version of the representative key used in operation 129, the representative key used in operation 129, and the encrypted content key E(Total_Key, CK) are recorded; a tag 908 in which information regarding the encrypted content key E(Total_Key, CK) used in operation 129 is recorded; and a payload 909 in which the encrypted content E(CK, Content) is recorded.

In operation 1220, the local server 42 broadcasts the message generated in operation 1210 to all of the devices currently residing in the local network.

An exemplary embodiment of the present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet).

According to an exemplary embodiment of the present invention, in a local network, it is possible for a local server having a small storage capacity to provide content encrypted in a broadcast encryption scheme to a plurality of devices in its local network by storing only a minimal number of keys needed by the devices to decode the encrypted content.

In addition, it is possible to prevent a device in the local network which is revoked from obtaining content provided by the local server by updating the keys stored in the local server according to whether the keys stored in the local server are revoked.

Moreover, since a representative key representing the minimal number of keys needed by the devices in the local network to decode the encrypted content is broadcasted to the devices in the local network, a content key used for generating the encrypted content can be encoded by performing only one iteration of encoding, and the encrypted content key can be decoded by performing only one iteration of decoding.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing content encrypted in a predetermined encryption scheme to a plurality of devices in a local network, the method comprising:
storing a minimal number of keys needed by the devices to decode the encrypted content among a plurality of keys that can be used in the predetermined encryption scheme; and
transmitting the stored keys to the devices.

2. The method of claim 1, wherein, in the predetermined encryption scheme, the encrypted content and a content key used for generating the encrypted content are broadcasted to the devices, and the transmitting comprises broadcasting the stored keys to the devices.

3. The method of claim 1, wherein the storing comprises storing a minimal number of keys needed by the devices to decode the encrypted content among a plurality of keys that are not revoked in the predetermined encryption scheme.

4. The method of claim 1 further comprising updating the stored keys according to whether the stored keys are revoked.

5. The method of claim 1, wherein the updating comprises updating the stored keys with a plurality of keys of a device that has entered the local network if the version of the keys of the device that has entered the local network is higher than the version of the stored keys.

6. The method of claim 4, wherein the updating comprises updating the stored keys with a plurality of keys stored in an arbitrary content received from outside the local network if the version of the keys stored in the received arbitrary content is higher than the version of the stored keys.

7. An apparatus for providing content encrypted in a predetermined encryption scheme to a plurality of devices in a local network, the apparatus comprising:
a storage unit which stores a minimal number of keys needed by the devices to decode the encrypted content among a plurality of keys that can be used in the predetermined encryption scheme; and
a transmission unit which transmits the keys stored in the storage unit to the devices.

8. The apparatus of claim 7 further comprising an updating unit which updates the keys stored in the storage unit according to whether the keys stored in the storage unit are revoked.

9. A computer-readable recording medium storing a computer program for executing a method of providing content encrypted in a predetermined encryption scheme to a plurality of devices in a local network, the method comprising:
storing a minimal number of keys needed by the devices to decode the encrypted content among a plurality of keys that can be used in the predetermined encryption scheme; and
transmitting the stored keys to the devices.

10. A method of providing content encrypted in a predetermined encryption scheme to a plurality of devices in a local network, the method comprising:
storing a representative key that represents a minimal number of keys needed by the devices to decode the encrypted content among a plurality of keys that can be used in the predetermined encryption scheme; and
transmitting the stored representative key to the devices.

11. The method of claim 10, wherein, in the predetermined encryption scheme, the encrypted content and a content key used for generating the encrypted content are broadcasted to the devices, and the transmitting comprises broadcasting the stored representative key to the devices.

12. The method of claim 11, wherein the storing comprises storing a representative key that represents a minimal number of keys needed by the devices to decode the encrypted content among a plurality of keys that are not revoked in the predetermined encryption scheme.

13. The method of claim 11 further comprising updating the stored representative key according to whether the minimal number of keys needed by the devices to decode the encrypted content are revoked.

14. The method of claim 13, wherein the updating comprises updating the stored representative key with a representative key possessed by a device that has entered the local network if the version of the representative key possessed by the device that has entered the local network is higher than the version of the stored representative key.

15. The method of claim 13, wherein the updating comprises updating the stored representative key with a representative key contained in an arbitrary content received from outside the local network if the version of the representative key contained in the received arbitrary content is higher than the version of the stored representative key.

16. An apparatus for providing content encrypted in a predetermined encryption scheme to a plurality of devices in a local network, the apparatus comprising:
a storage unit which stores a representative key that represents a minimal number of keys needed by the devices to decode the encrypted content among a plurality of keys that can be used in the predetermined encryption scheme; and
a transmission unit which transmits the representative key stored in the storage unit to the devices.

17. The apparatus of claim 16 further comprising an updating unit which updates the representative key stored in the storage unit according to whether the minimal number of keys needed by the devices to decode the encrypted content are revoked.

18. A computer-readable recording medium storing a computer program for executing a method of providing content encrypted in a predetermined encryption scheme to a plurality of devices in a local network, the method comprising:
storing a representative key that represents a minimal number of keys needed by the devices to decode the encrypted content among a plurality of keys that can be used in the predetermined encryption scheme; and
transmitting the stored representative key to the devices.
